(19) United States
(12) Patent Application Publication
(10) Pub. No.: US 2002/0067280 A1
(43) Pub. Date: Jun. 6, 2002

(54) Method and apparatus for a portable remotely controlled tennis scoreboard

(76) Inventors: Gilbert Carrillo, Univeral City, TX (US); Philip Weiss, Pasadena, CA (US)

Correspondence Address: Abraham N. Seidman, LAW OFFICE OF ABRAHAM SEIDMAN & ASSOCIATES, P O Box 16603, Beverly Hills, CA, 90209, US

(21) Appl. No.: 09/729,052

(22) Filed: Dec. 4, 2000

Related U.S. Application Data
(60) Provisional application No. 60/168,944, filed on Dec. 3, 1999.

(51) Int. Cl. G08B 5/00

(52) U.S. Cl. 340/815.4; 340/540

(57) ABSTRACT

Remotely controlled tennis scoreboard, which operates from batteries or ordinary A/C (110 or 220 volts). The tennis scoreboard is lightweight and not bulky. The remote control units are small, lightweight battery powered units. The tennis scoreboard has two parts, first, the main electronics and display unit, and second, a handheld control unit for setting the score. Typically each player or side uses a remote unit, so that during a game two remote control units and the main display/electronics are in use. A highly visible display is used so that it is visible indoors or outdoors. It is visible in bright sunlight or under evening or night playing conditions (under the lights). A portable version of this invention weighs 10 pounds or less.

This application claims the benefit of Provisional Application No. 60/168944 filed Dec. 3, 1999.

### FIELD OF THE INVENTION

This invention relates to portable tennis scoreboards. It relates to scoreboards, which can be changed by a remote control unit.

### BACKGROUND OF THE INVENTION

Various types of scoreboards are known in the art. Gardner (U.S. Pat. 3,981,002) shows a portable electronic display device. The device was called out to weigh less than 50 to 75 pounds. A truly portable and effective tennis scoreboard with a remotely actuated score would be a desirable invention. Tennis clubs and other organizations such as schools have a significant demand for an inexpensive, battery-operated tennis scoreboard. A version of this scoreboard, which can run off regular household AC, is also desirable.

### SUMMARY OF THE INVENTION

The invention is a remotely set tennis scoreboard, which operates from batteries or ordinary A/C (110 or 220 volts). The tennis scoreboard is lightweight and not bulky. The remote control units are small, lightweight battery powered units. The tennis scoreboard has two parts, first, the main electronics and display unit, and second, a handheld control unit for setting the score. Typically each player or side uses a remote unit, so that during a game two remote control units and the main display/electronics are in use. A highly visible display is used so that it is visible indoors or outdoors. It is visible in bright sunlight or under evening or night playing conditions (under the lights). A portable version of this invention weighs less than 30 pounds; a preferred version weighs less than 10 pounds.

### BRIEF DESCRIPTION OF THE DRAWINGS

The above and other features and advantages of the invention will be more apparent from the following detailed description wherein:

FIG. 1a shows the block diagram of the scoreboard, remote control units, and the switch panel;

FIG. 1b depicts a second level of detail block diagram for the components of FIG. 1a;

FIG. 2a illustrates the “Tournament” embodiment of the display showing set, game and elapsed time indicators with the area for the switch panel;

FIG. 2b shows the “Personal” embodiment of the display with the display for game scoring;

FIG. 3a shows the “Player” remote breaking out the antenna, RF transmitter, decoder, battery, with advance and select buttons, only;

FIG. 3b shows the “Master” remote breaking out the antenna, RF transmitter, decoder, battery, with configure, advance and select buttons;

FIG. 4 depicts the block diagram for the electronics assembly, including antenna, RF receiver, RF decoder, micro-controller, scoreboard display driver, power control, with switch panel decoder and switch panel;

FIG. 5a shows the circular cylindrical clear acrylic housing with a card slip-in slot;

FIG. 5b shows the circular cylindrical clear acrylic housing with and electromechanical/electronic display for sponsors and player names;

FIG. 6a shows a circular cylindrical housing;

FIG. 6b shows a triangular prismatic (cylinder) housing;

FIG. 6c shows the housing of FIG. 6b, but with rounded vertical edges;

FIG. 6d shows a rectangular prismatic (cylinder) housing;

FIG. 6e shows the housing of FIG. 6d with rounded edges;

FIG. 6f shows a square prismatic (cylinder) housing;

FIG. 6g shows the housing of FIG. 6f with rounded edges

### DETAILED DESCRIPTION OF THE PREFERRED EMBODIMENT

The following description is of the best mode presently contemplated for carrying out the invention. This description is not to be taken in a limiting sense, but is merely made for the purpose of describing the general principles of the invention. The scope of the invention should be determined with reference to the claims.

The invention is a remotely set tennis scoreboard, which operates from batteries or ordinary A/C (110 or 220 volts). The tennis scoreboard is lightweight and not bulky. The remote control units are small, lightweight battery powered units. The tennis scoreboard has two parts, first, the main electronics and display unit, and second, a handheld control unit for setting the score. Typically each player or side uses a remote unit, so that during a game two remote control units and the main display/electronics are in use.

A highly visible display is used so that it is visible indoors or outdoors. It is visible in bright sunlight or under evening or night playing conditions (under the lights).

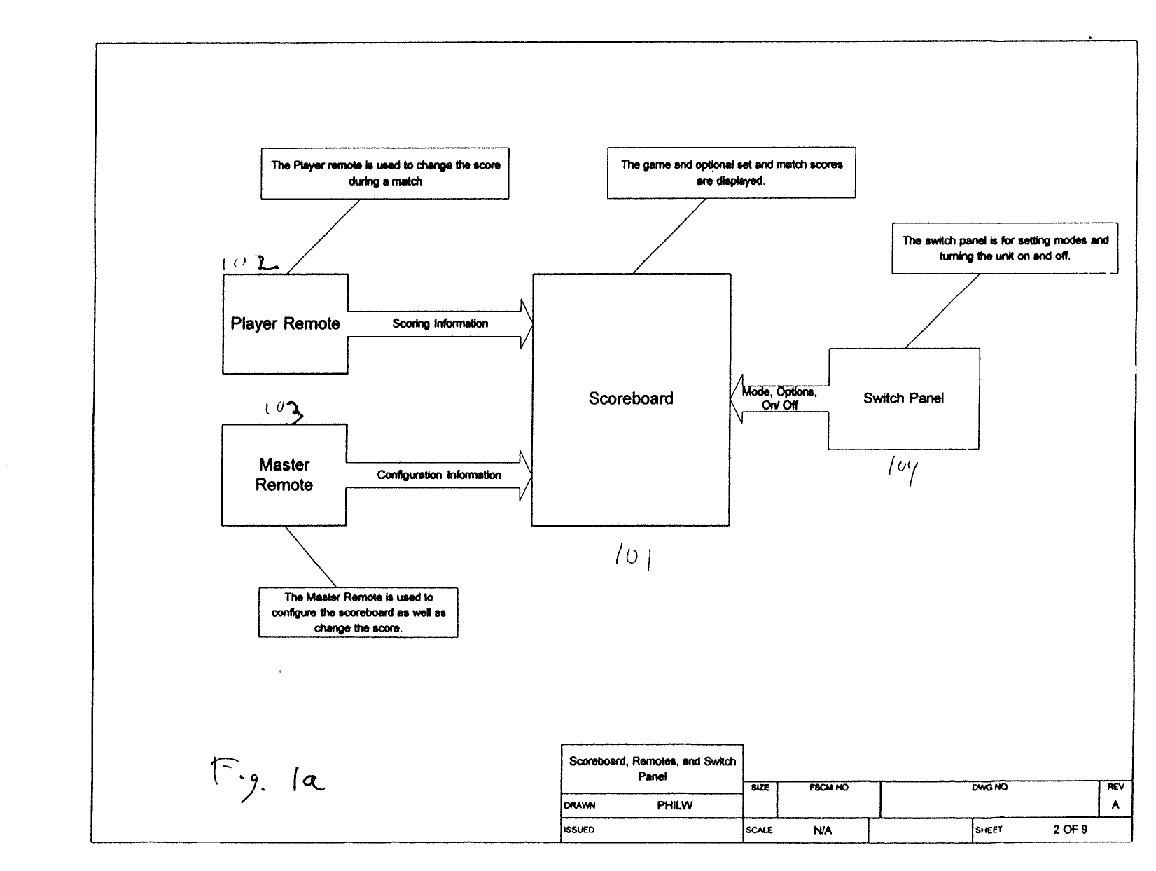

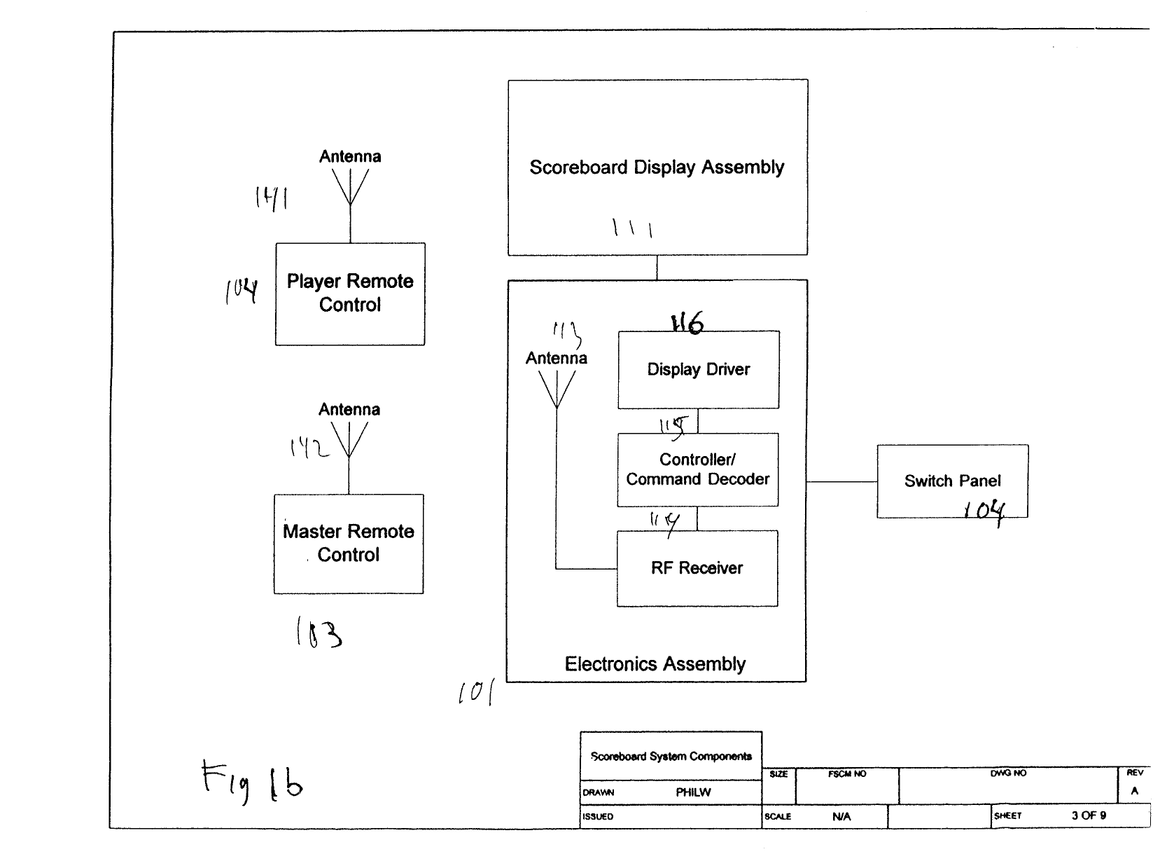

FIG. 1a shows the block diagram of the scoreboard (101), remote control units, player unit (102), master control unit (103) and the switch panel (104)which are depicted as a block diagram in FIG. la. The scoreboard and optional set and match scores are displayed by the scoreboard (101). The master remote (103) configures the scoreboard as well as changes the score during the match. The player remote (102) changes the score during the match. One player has the master control unit while the other player has the player unit. The scoreboard display is alphanumerical, with numerals only where alphabet characters are not required. Several off-the-shelf display subassemblies are utilized in different embodiments of this invention. These include, but are not limited to, electromechanical flip assemblies, light-emitting diode arrays (LEDs), electromagnetic flip disks, liquid crystal displays, plasma displays, and cathode ray tubes (CRTs).

The preferred embodiments include the electromechanical displays, the electromagnetic flip disks and the light emitting diode array displays. The electromechanical display works by flipping a lightweight small panel with an alphanumeric character printed, painted, or otherwise attached to the small panel. The mechanisms of activating the flip movement include motors, stepping motors, and relays. The 25 electromagnetic flip disk display works by flipping individual disks electromagnetically, thus using power only during the time the disks are flipped. Otherwise the disks are static and no power is used. The disks themselves are bright white or other color, on one side, and black on the other.

These disks can form very visible alphanumeric displays. The height and width of the letters are not limited, except by the requirement that they can 30 be seen by the players, in the “Personal” embodiment and by the players and spectators, in the case of the “Tournament” embodiment. The proportional sized numbers (and letters, if any) may have a height from 2 inches to 24 inches or more, however, in a preferred mode the height of the alphanumerical digits is 2 inches to 6 inches.

FIG. 1b depicts a second level of detail block diagram for the components of FIG. 1a. The scoreboard (101) is composed of a scoreboard display assembly (111), and an electronics assembly (112). The switch panel (104) is shown. The electronics assembly includes an antenna (113), an RF receiver (114), combined controller/command decoder (115) and a display controller (116). The player remote control (102) is equipped with an antenna (141) as is the master remote control (103), also with an antenna (141). In operation each player has a remote control unit that sends an 8-bit identifier and a four bits of data in a serial format which is received by the antenna and RF receiver of the electronics assembly where the serial code is converted to parallel bit streams. The RF receiver and controller/command decoder only accept commands from remote control units with a corresponding identification code.

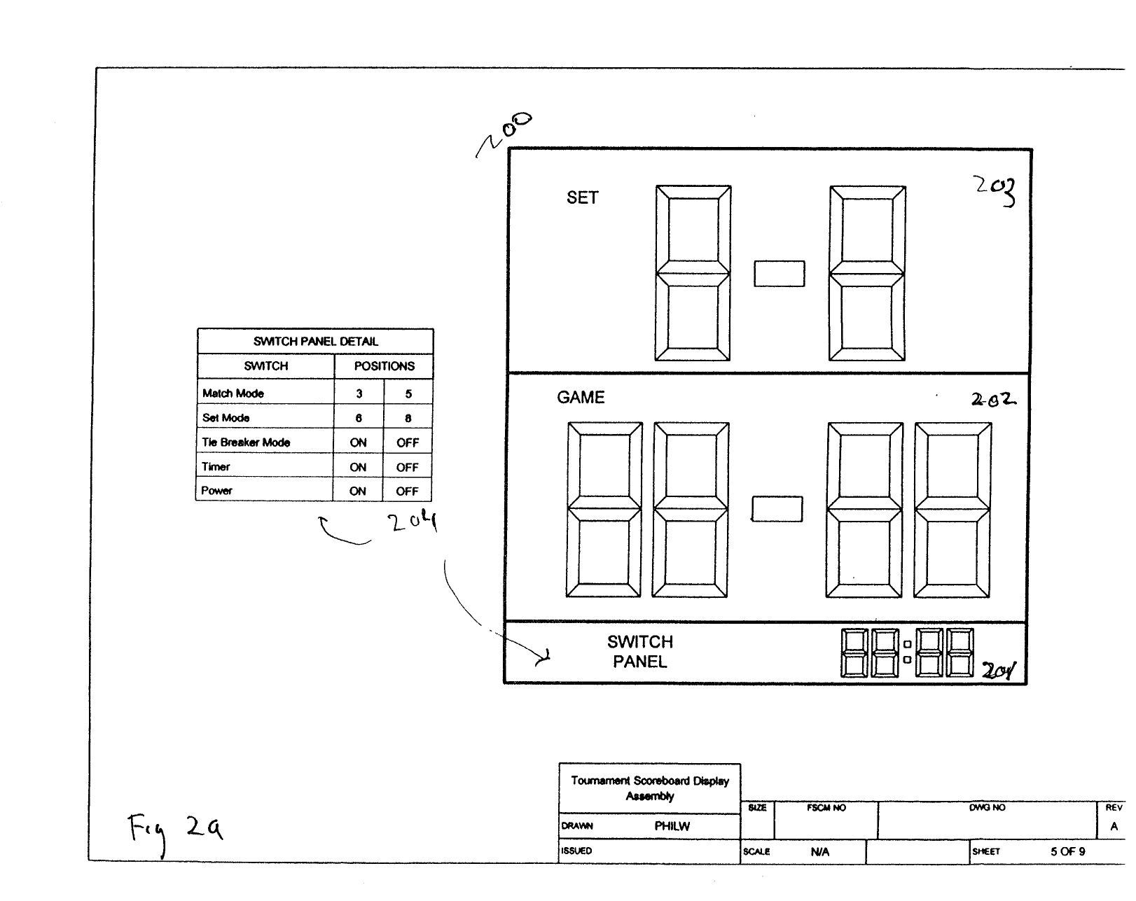

In a “Tournament” embodiment (FIG. 2a) the scoreboard (200) shows time (201), games won for each player (202) and sets won by each player (203). The switch control panel (204) is further shown in FIG. 2a. There are five basic switch settings. The switch settings include match mode, either 3 or 5; and set mode, which is either 6 or 8. The tie breaker mode is set on or off. The timer is set to on or off. Power is set to on or off.

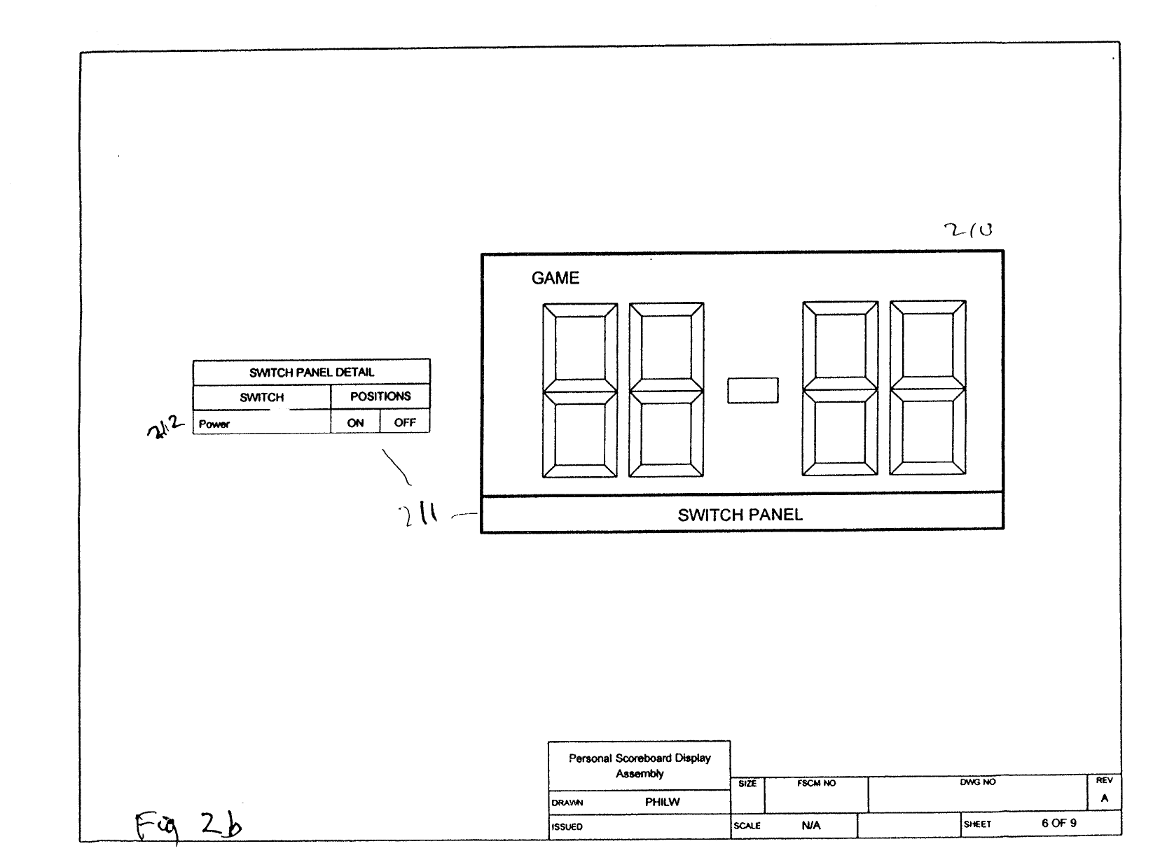

The “Personal” embodiment of the display with the display for game scoring is shown in FIG. 2b. The scoreboard (210) shows the games won by each player. The switch panel (211) has a basic switch for power with settings on and off. The “Personal” remote control unit as shown in FIG. 3b with its component elements: the antenna (311), RF transmitter (312), encoder (313), battery (314), with advance (315) and select (316) buttons, only. The select button (315) selects a scoreboard element to change. The advance button (316) increments the selected scoreboard element. The encoder (313) sets up the switch settings into 4-bit data, The 8-bit ID number is sent on the front end of the data bits. The data is fed into the RF transmitter (312) and sent out over the antenna (311).

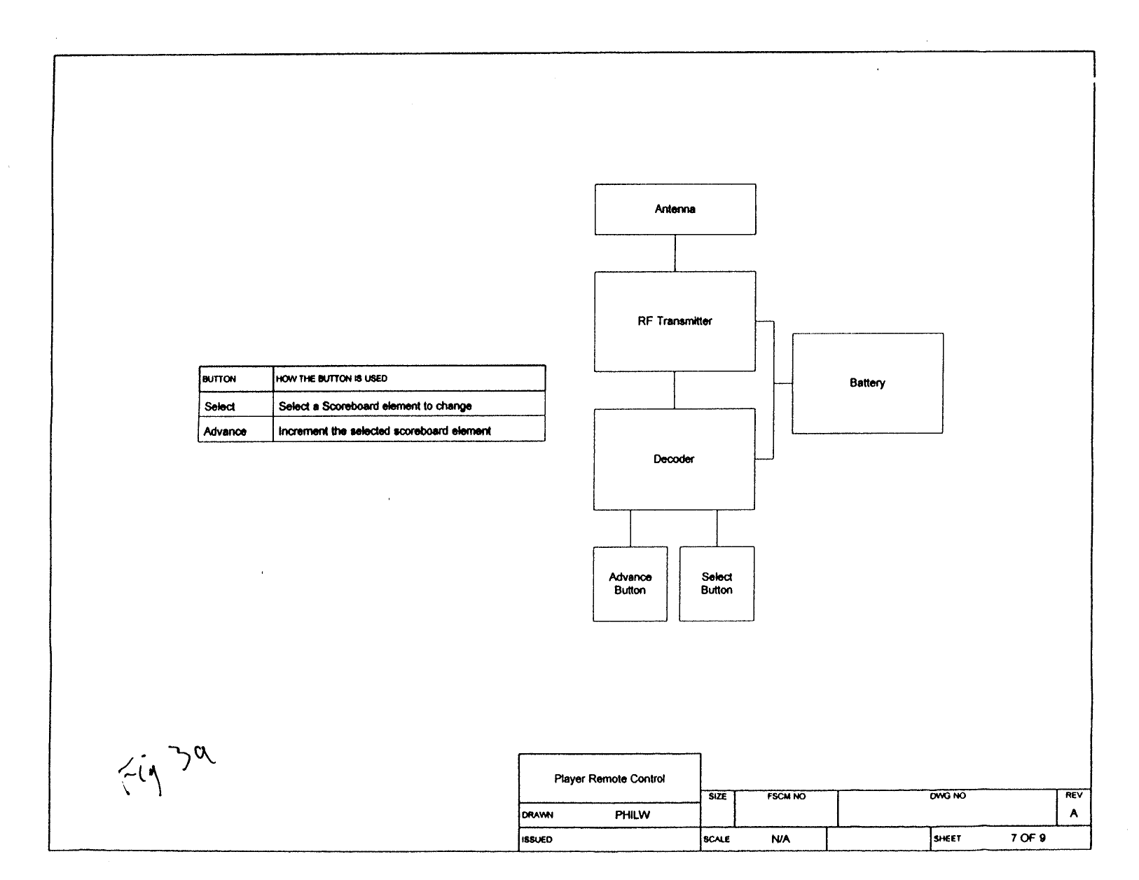

The “Master” remote has the antenna (311), RF transmitter (312), encoder (313), battery (314), advance (315) and select (316) buttons; with an additional button compared with the “Personal” remote, namely the configure (317) button. Again, The select button selects a scoreboard element to change. The advance button increments the selected scoreboard element. The encoder (313) sets up the switch settings into 4-bit data. The 8-bit ID number is sent on the front end of the data bits. The data is fed into the RF transmitter (312) and sent out over the antenna (311). The configure button (317) changes the control setting domain to five basic functions. These functions include match mode, either 3 or 5; and set mode, which is either 6 or 8. Also, the tie breaker mode is set on or off; the timer is set to on or off, and power is set to on or off. As in the case of the score changing case, the select button selects which of the configure elements is to be changed, in an endless loop fashion, advancing one function at a time. The advance button then is used to change the settings of that function. The electronics assembly (FIG. 4) includes an antenna (113), an RF receiver (114), RF decoder (125), micro-controller (135), scoreboard display driver (126), power control (401), with 10 switch panel decoder (410) and switch panel (104). The RF antenna (114) serves to receive the Rf signals sent out by the “personal” remote control unit or by the “master” remote control unit. The RF receiver (114), old in the art, receives the RF signal from a remote and strips out the RF frequency and sends the original pre-RF transmission signal modulated signal to the RF decoder (125) where the serial message is converted to a parallel bit stream. This parallel bit stream is sent into the micro-controller (135), which then operates the scoreboard display driver (126), which then activates the display for the current tennis score situation. The switch panel (104) is used to set the playing configuration settings, as discussed above, including the five functions: match mode, either 3 or 5; set mode, which is either 6 or 8; tie breaker mode which is either on or off; the timer which is either on or off; and power is either on or off. The switch panel (104) settings are translated to bit-code by the switch panel decoder (410), which in turn sets up the micro-controller (135). The input from the RF decoder (125) is thus constrained by the switch panel (104) setting choices.

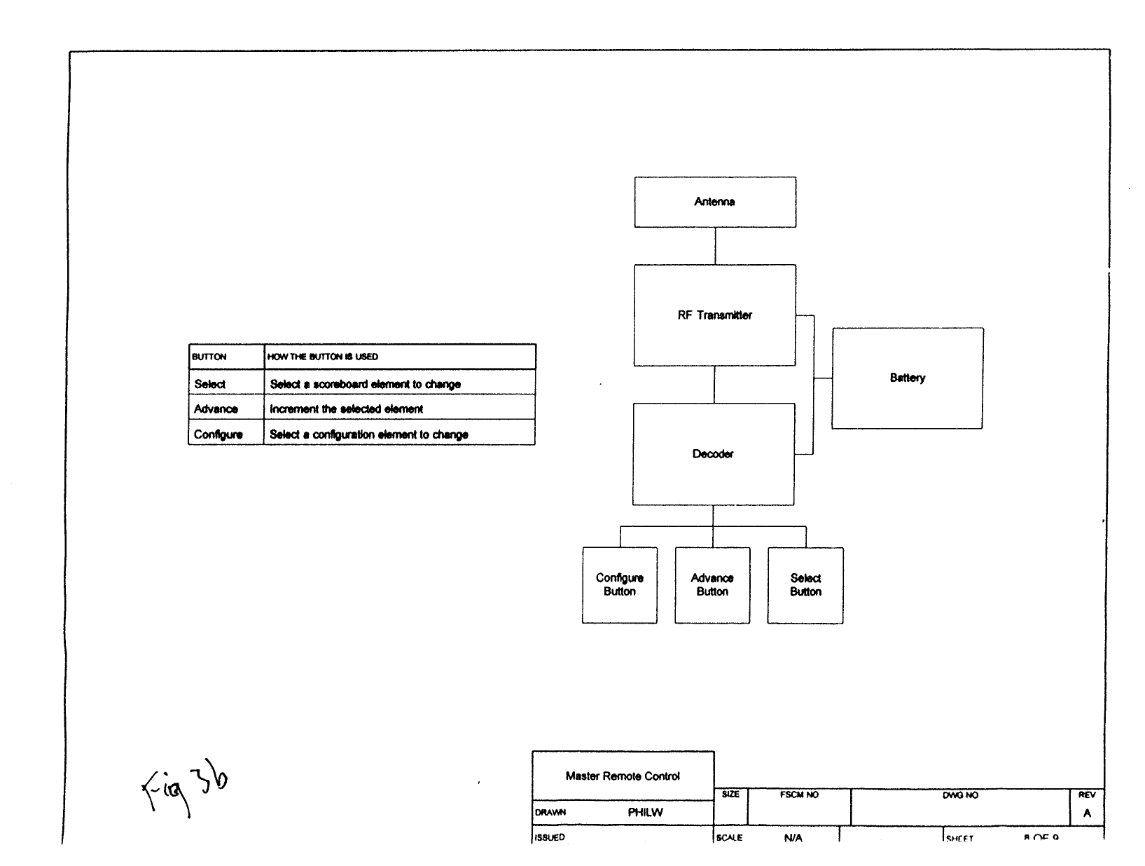

The housing of the unit, which includes the electronics assembly, is made out of different materials depending on the combination of weight, ruggedness and least cost desired. For example, acrylic plastic, with some areas of clear acrylic plastic for viewing the display assembly inside is suitable for a relatively strong, less expensive unit. Polycarbonate is another plastic material, which is suitable for including at least some clear areas as an integral part of the electronics assembly case. In the case where the acrylic or polycarbonate cases are formulated to be completely clear, and where the shape is that of a circular cylinder or prism (FIG. 5a, 501), an inside holder (503) can be molded into the plastic such that an elongated card (504) slipped into the inside holder through a vertical slit in the plastic housing can illustrate the sponsor's name or sponsors' names and another elongated card (505) the players' names; the card (504), (505), being slipped inside the housing cylinder (501).

FIG. 5b shows a sponsor (510) and player name (511) display with alphanumeric display elements (510), (511) either, electromechanical, or electromagnetic flip disks or electronic, viz., light emitting diode arrays or liquid crystal arrays which may be illuminated from the back, side or front. The switch control for the sponsor alphanumeric display (520) and the switch control for the player name alphanumeric display (521) are attached by a plurality of control wires (5201) and (5211), respectively to the alphanumeric display controllers (not shown) within the housing (501). Both of the switch control units are storable within the cylinder housing in a chamber within the housing, closed in by the curved door (530), which is shaped to conform to the cylinder.

Other materials include titanium, stainless steel, galvanized steel, aluminum, magnesium, honeycomb aluminum, graphite composite, graphite fiber reinforced plastic, and generally plastics.

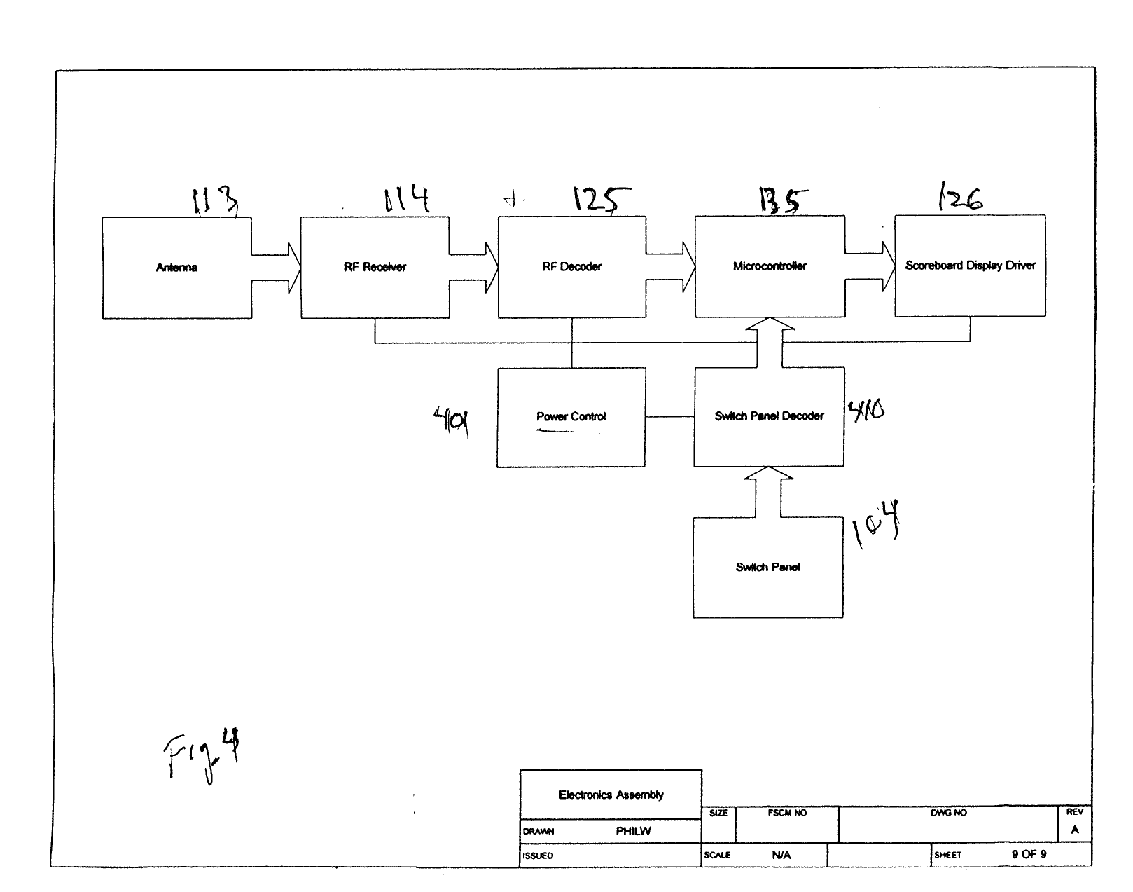

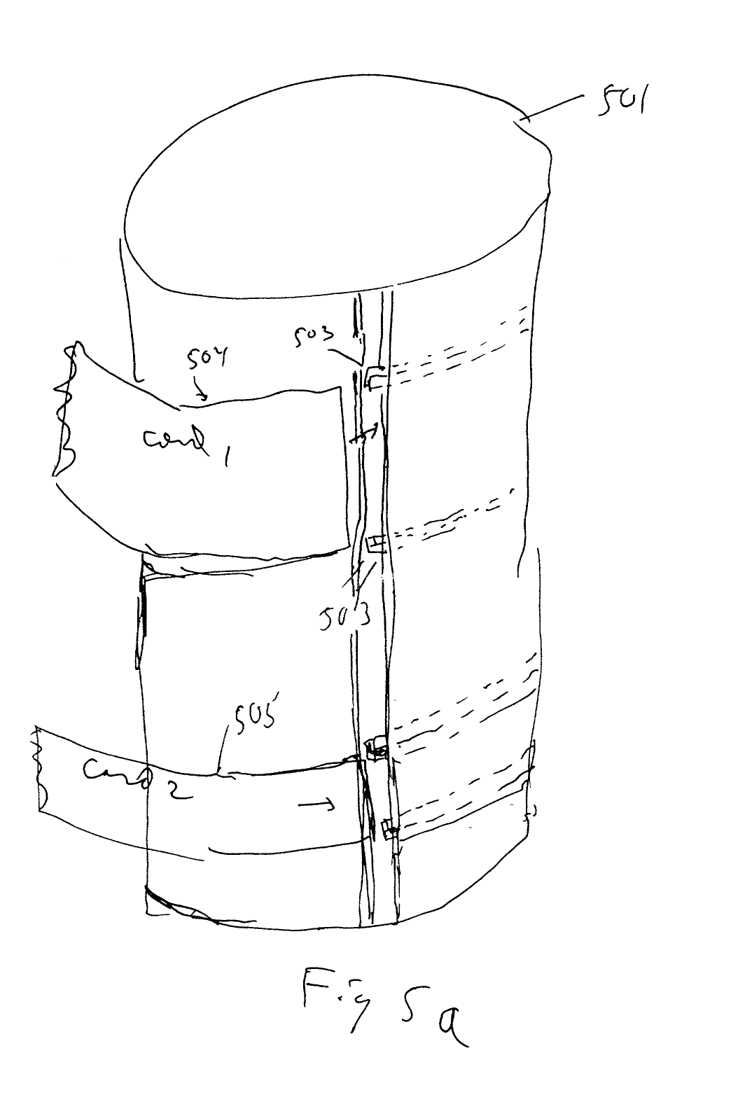

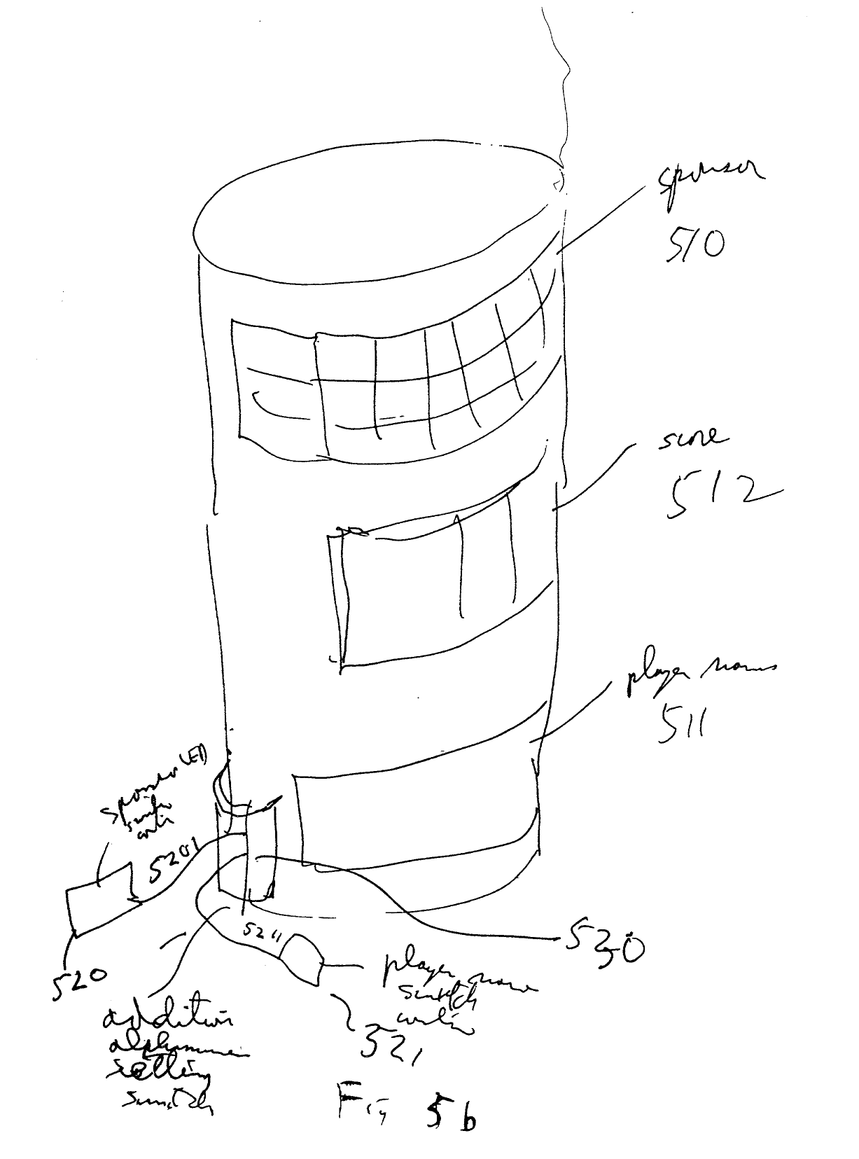

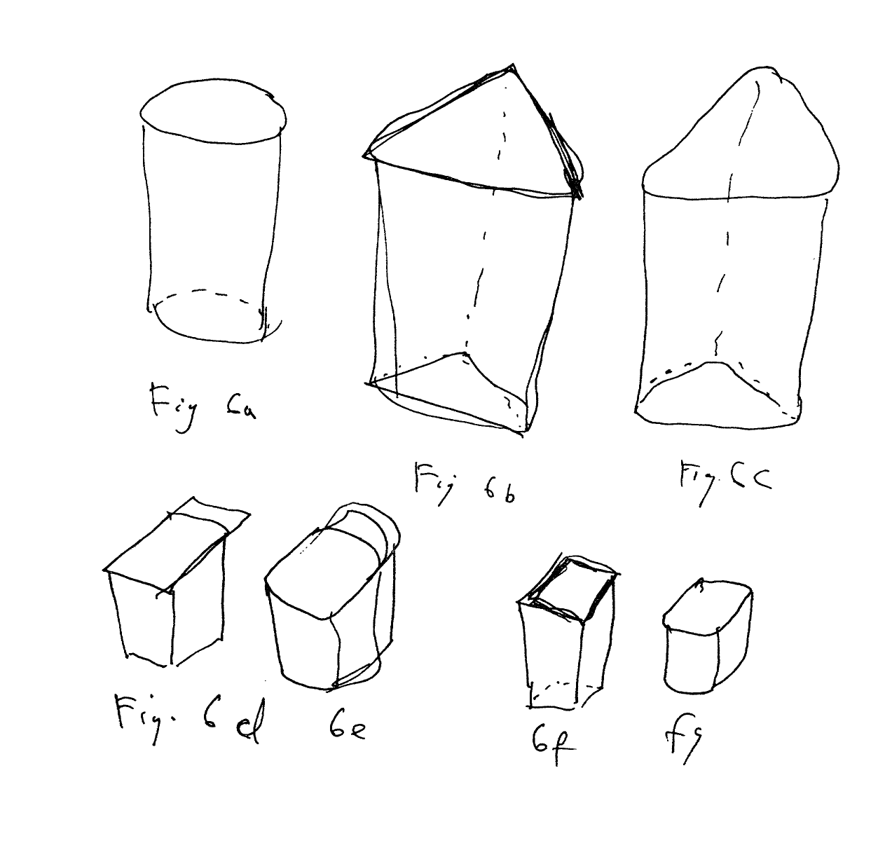

A preferred shape for the housing is cylindrical (see FIG. 6a), although other aspects or embodiments of the invention include, a triangular (see FIG. 6b) cylinder or prismatic shape, a triangular cylinder or prismatic shape with rounded vertical edges (see FIG. 6c), a rectangular or square cylinder or prismatic shape with sharp or rounded vertical edges (see FIG. 6d, 6e, 6f and 6g, respectively).

While the invention herein disclosed has been described by means of specific embodiments and applications thereof, numerous modifications and variations could be made thereto by those skilled in the art without departing from the scope of the invention set forth in the claims.

What is claimed is:

1. An apparatus comprising a display, an electronics unit, one or more remote control units wherein said remote units change a displayed score; said display configured for showing a game score; said electronics unit portable and operable upon a power source.

2. The apparatus of claim 1 wherein said power source is at least one battery.

3. The apparatus of claim 1 wherein said power source is regular alternating current (A/C) of a voltage range selected from the group consisting of 100 volts to 130 volts and 200 to 230 volts.

4. The apparatus of claim 1 wherein the game score is a tennis game score.

5. The apparatus of claim 1 further comprising the display selected from the group consisting of electromechanical flip assemblies, light-emitting diode arrays (LEDs), electromagnetic flip disks, liquid crystal displays, plasma displays, and cathode ray tubes (CRTs); wherein the heights of the alphanumerical characters are within the range from 1 inch to 24 inches.

6. The apparatus of claim 1 wherein the display is a light emitting diode display; and wherein the alphanumeric characters from 2 inches high to 12 inches high.

7. An method for making a remotely controlled game scoreboard comprising the steps of a utilizing a display; utilizing an electronics unit; utilizing one or more remote control units; wherein said remote units change a displayed score; configuring said display for showing a game score; operating said electronics unit as a portable unit; operating portable unit upon a power source.

8. The method of claim 7 further comprising the step of utilizing at least one battery for the power source.

9. The method of claim 7 further comprising the step of utilizing household type alternating current (A/C) of a voltage range selected from the group consisting of 100 volts to 130 volts and 200 to 230 volts, for said power source.

10. The method of claim 7 further comprising the step of utilizing the remotely controlled game scoreboard as a tennis scoreboard.

11. The method of claim 7 further comprising the step of selecting a display from the group consisting of electromechanical flip assemblies, light-emitting diode arrays (LEDs), electromagnetic flip disks, liquid crystal displays, plasma displays, and cathode ray tubes (CRTs); wherein the heights of the alphanumerical characters are within the range from 1 inch to 24 inches.

12. The method of claim 7 further comprising the step of selecting a light emitting diode display; wherein the alphanumeric characters from 2 inches high to 12 inches high.
